(19) United States
(12) Patent Application Publication
(10) Pub. No.: US 2025/0156378 A1
(43) Pub. Date: May 15, 2025

(54) CONTENT ITEM ANALYTICS TIMELINE

(71) Applicant: Dropbox, Inc., San Francisco, CA (US)

(72) Inventor: Christopher Allen, San Mateo, CA (US)

(21) Appl. No.: 18/411,603

(22) Filed: Jan. 12, 2024

Related U.S. Application Data
(60) Provisional application No. 63/598,232, filed on Nov. 13, 2023.

(51) Int. Cl. G06F 16/176; H04L 67/50

(52) U.S. Cl. CPC G06F 16/176; H04L 67/535

(57) ABSTRACT

The present technology pertains to displaying granular viewer interactions for how viewers are viewing shared content items, such as videos, over time. A sharing and tracking service of a sharing platform associated with or managed by a content management system provides the granular viewer interactions of viewer interactions that retrace a full journey of views of shared content items in a content item interaction analytics timeline. The content item interaction analytics timeline may provide a visual representation of how the viewer interacts with the content item (e.g., how the user is scrolling through the different segments) throughout the viewing.

### CROSS-REFERENCE TO RELATED APPLICATIONS

This application claims the benefit of priority to U.S. Provisional Patent Application No. 63/598,232, filed on Nov. 13, 2023, which is expressly incorporated by reference herein in its entirety.

### BACKGROUND

Computing devices provide various ways for users to interact with digital content items. Additionally, users have many different software tools to perform a variety of analytics of engagement with how users interact with digital content items. For example, users view and interact with different kinds of content items (i.e., documents, spreadsheets, folders containing a set of content items, etc.) and their engagement can be captured.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings, and the claims.

FIG. 1 illustrates an example of a content management system and client devices in accordance with some aspects of the present technology.

FIG. 2 illustrates a method for generating a timeline view of navigation through presented content items from a custom link in accordance with some aspects of the present technology.

FIG. 3 illustrates an example graphical display that includes a content item interaction analytics timeline in accordance with some aspects of the present technology.

FIG. 4 illustrates an example graphical display that includes a preview and a content item interaction analytics timeline in accordance with some aspects of the present technology.

FIG. 5 illustrates an aspect of the subject matter in accordance with some aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The present technology addresses the need for granular analytics related to viewer interactions of shared content items in a timeline. The shared content items may include documents, spreadsheets, and virtual data rooms (VDRs) containing sets of content items. A viewer interaction is any interaction a user may take with respect to a content item (e.g., opening a document, moving from a first page to a second page, downloading a document, etc.). Viewer interactions may include interactions with portions of content items, including page change events, link selection events within a page, download events, page element selection events, etc.. In other words, viewer interactions may include any type of engagement a viewer may have with a content item.

The viewer interactions may be retraced as a full journey of every view of the shared content item and be provided as a visual representation of how the viewer engaged with the content item. For example, if the content item is a single document, the viewer interactions may include a user viewing a first page, the user changing to view a second page, the user clicking a link in the document, or the user downloading the document. As another example, if the content item is a VDR that contains sets of content items, the viewer interactions may include the user opening a particular content item, the user changing between pages in a particular content item, or the user selecting or engaging with certain features of the content items.

Once viewers engage with the content item, viewer interactions may be populated in real-time in a graphical display, such as in a timeline form. In some examples, the graphical display may be provided to an administrator associated with the content item.

In addition, actionable insights may be provided to allow a user to modify the content item based on the tracked viewer interactions. An actionable insight is an insight relating to a content item based on analysis of the viewer interactions associated with the content item, where that insight provides an actionable suggestion or recommendation related to the content item based on the analysis. For example, the tracked viewer interactions may indicate that a particular type of viewer is skipping pages two to three of a content item and only viewing pages one, four, and five. An actionable insight may recommend deleting pages two and three, combining pages two and three, or reordering the pages. The actionable insights may be improved over time based on which actionable insights are implemented.

In some cases, the present technology may also efficiently store data associated with the viewer interactions, such as page views, download events, and content item link clicks, by aggregating the data points through an extract, transform, and load (ETL) pipeline. Using the ETL pipeline, some of the data points may be transformed before they are stored for reading as a way to more efficiently store data.

The present technology thus addresses current problems in the art by making it easier to view the viewer interactions in each visit to a content item by a viewer such that a full journey is retraced. In this way, the present technology reduces each of the multiple action steps of prior art solutions, requiring fewer burdens on both a computing system (by needing to navigate to and render fewer interfaces) and a user (by reducing the number of steps they need to perform). The present technology also addresses current problems in the art by providing storage indexes for the viewer interactions that aggregates the different viewer interactions in an efficient manner.

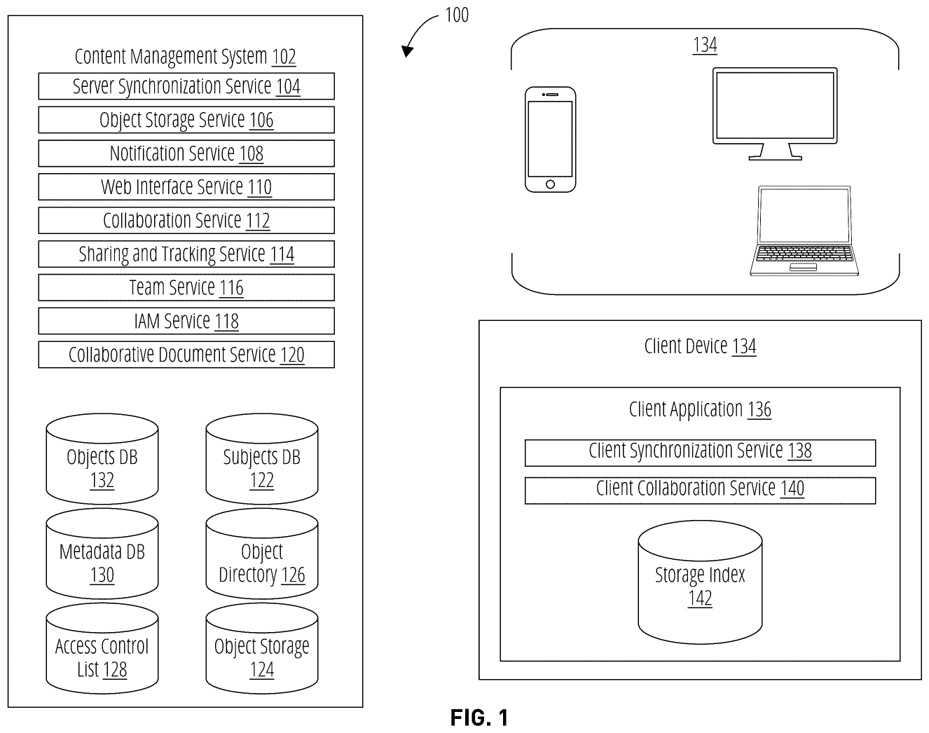

In some embodiments, the disclosed technology is deployed in the context of a content management system having content item synchronization capabilities and collaboration features, among others. An example system configuration 100 is shown in FIG. 1, which depicts content management system 102 interacting with client device 134.

### Accounts

Content management system 102 can store content items in association with accounts, as well as perform a variety of content management tasks, such as retrieve, modify, browse, and/or share the content item(s). Furthermore, content management system 102 can enable an account to access content item(s) from multiple client devices.

Content management system 102 supports a plurality of accounts. A subject (user, group, team, company, etc.) can create an account with content management system, and account details can be stored in subject database 122. Subject database 122 can identify a registered subject by a subject ID, and store profile information for registered subjects in association with the subject ID. In some cases, profile information for registered subjects includes a subject name and/or email address. Subject database 122 can include account management information, such as account type (e.g. various tiers of free or paid accounts), storage space allocated, storage space used, client devices 134 having a registered content management client application 136 resident thereon, security settings, personal configuration settings, etc. In some embodiments, some information associated with an account may not be directly stored, and rather this information can be derived. For example, storage space used might be explicitly stored, or it can be calculated when needed.

In some embodiments, subject database 122 need not store complete information associated with an account for a subject. Some portion of information associated with an account for a subject can also be stored in another database of content management system 102 such as metadata database 130, or in a database external to content management system 102.

Subject database 122 can store groups of accounts associated with a subject. Groups can have permissions based on group permissions statements and/or access control lists, and members of the groups can inherit the permissions. For example, a marketing group can have access to one set of content items while an engineering group can have access to another set of content items. An administrator group can modify groups, modify subject accounts, etc. Groups are also subjects identified by subject ID.

In some embodiments, subject database 122 can be broken into a plurality of tables, indexes and other data structures.

### Content Item Storage

A feature of content management system 102 is the storage of content items, which can be stored in content item storage 124. A content item generally is any entity that can be recorded in a file system. Content items can be any content item including digital data such as documents, collaboration content items, text files, audio files, image files, video files, webpages, executable files, binary files, content item directories, folders, zip files, playlists, albums, symlinks, cloud docs, mounts, placeholder content items referencing other content items in content management system 102 or in other content management systems, etc.

In some embodiments, content items can be grouped into a collection, which can refer to a folder including a plurality of content items, or a plurality of content items that are related or grouped by a common attribute.

In some embodiments, content item storage 124 is combined with other types of storage or databases to handle specific functions. Content item storage 124 can store content items, while metadata regarding the content items can be stored in metadata database 130. Likewise, data regarding where a content item is stored in content item storage 124 can be stored in content item directory 126. Additionally, data regarding changes, access, etc. can be stored in content items database 132. Content items database 132 can also include a subject account identifier that identifies the subject IDs that have access to the content item.

In some embodiments, content items database 132 can be broken into a plurality of tables, indexes and other data structures.

Each of the various storages/databases such as content item storage 124, content item directory 126, content items database 132, and metadata database 130 can be comprised of more than one such storage or database and can be distributed over many devices and locations. Other configurations are also possible. For example, data from content item storage 124, content item directory 126, content items database 132, and/or metadata database 130 may be combined into one or more content item storages or databases or further segmented into additional content item storages or databases. Thus, content management system 102 may include more or less storages and/or databases than shown in FIG. 1.

In some embodiments, content item storage 124 is associated with at least one content item storage service 106, which includes software or other processor executable instructions for managing the storage of content items including, but not limited to, receiving content items for storage, preparing content items for storage, selecting a storage location for the content item, retrieving content items from storage, etc. In some embodiments, content item storage service 106 can divide a content item into smaller chunks for storage at content item storage 124. The location of each chunk making up a content item can be recorded in content item directory 126. Content item directory 126 can include a content entry for each content item stored in content item storage 124. The content entry can be associated with a content item ID, which uniquely identifies a content item.

In some embodiments, each content item and each chunk of a content item can also be identified from a deterministic hash function. This method of identifying a content item and chunks of content items can ensure that content item duplicates are recognized as such since the deterministic hash function will output the same hash for every copy of the same content item, but will output a different hash for a different content item. Using this methodology, content item storage service 106 can output a unique hash for each different version of a content item.

Content item storage service 106 can also designate or record a parent of a content item or a content path for a content item in content items database 132. The content path can include the name of the content item and/or folder hierarchy associated with the content item. For example, the content path can include a folder or path of folders in which the content item is stored in a local file system on a client device. In some embodiments, content item database might only store a direct ancestor or direct child of any content item, which allows a full path for a content item to be derived, and can be more efficient than storing the whole path for a content item.

While content items are stored in content item storage 124 in blocks and may not be stored under a tree like directory structure, such directory structure is a comfortable navigation structure for subjects viewing content items. Content item storage service 106 can define or record a content path for a content item wherein the “root” node of a directory structure can be any directory with specific access privileges assigned to it, as opposed to a directory that inherits access privileges from another directory.

In some embodiments, a root directory can be mounted underneath another root directory to give the appearance of a single directory structure. This can occur when an account has access to a plurality of root directories. As addressed above, the directory structure is merely a comfortable navigation structure for subjects viewing content items, but does not correlate to storage locations of content items in content item storage 124.

While the directory structure in which an account views content items does not correlate to storage locations of the content items at content management system 102, the directory structure can correlate to storage locations of the content items on client device 134 depending on the file system used by client device 134.

As addressed above, a content entry in content item directory 126 can also include the location of each chunk making up a content item. More specifically, the content entry can include content pointers that identify the location in content item storage 124 of the chunks that make up the content item.

Content item storage service 106 can decrease the amount of storage space required by identifying duplicate content items or duplicate blocks that make up a content item or versions of a content item. Instead of storing multiple copies, content item storage 124 can store a single copy of the content item or block of the content item, and content item directory 126 can include a pointer or other mechanism to link the duplicates to the single copy.

Content item storage service 106 can also store metadata describing content items, content item types, folders, file path, and/or the relationship of content items to various accounts, collections, or groups in metadata database 130, in association with the content item ID of the content item.

Content item storage service 106 can also store a log of data regarding changes, access, etc. in content items database 132. Content items database 132 can include the content item ID of the content item and can optionally include a description of the change or access action along with a time stamp or version number and any other relevant data. Content items database 132 can also include pointers to blocks affected by the change or content item access. Content item storage service 106 can also provide the ability to undo operations, by using a content item version control mechanism that tracks changes to content items, different versions of content items (including diverging version trees), and a change history that can be acquired from content items database 132.

### Content Item Synchronization

Another feature of content management system 102 is synchronization of content items with at least one client device 134. Client devices 134 can take different forms and have different capabilities. For example, client device 134 can be a computing device having a local file system accessible by multiple applications resident thereon. Client device 134 can be a computing device wherein content items are only accessible to a specific application or by permission given by the specific application, and the content items are typically stored either in an application-specific space or in the cloud. Client device 134 can be any client device accessing content management system 102 via a web browser and accessing content items via a web interface. While example client device 134 is depicted in form factors such as a laptop, mobile device, or web browser, it should be understood that the descriptions thereof are not limited to devices of these example form factors. For example, a mobile device might have a local file system accessible by multiple applications resident thereon, or might access content management system 102 via a web browser. As such, the form factor should not be considered limiting when considering client device's 134 capabilities. One or more functions described herein with respect to client device 134 may or may not be available on every client device depending on the specific capabilities of the device—the file access model being one such capability.

In many embodiments, client devices 134 are associated with an account of content management system 102, but in some embodiments, client device 134 can access content using shared links and do not require an account.

As noted above, some client devices can access content management system 102 using a web browser. However, client devices can also access content management system 102 using client application 136 stored and running on client device 134. Client application 136 can include a client synchronization service 138.

Client synchronization service 138 can be in communication with server synchronization service 104 to synchronize changes to content items between client device 134 and content management system 102.

Client device 134 can synchronize content with content management system 102 via client synchronization service 138. The synchronization can be platform agnostic. That is, content can be synchronized across multiple client devices of varying types, capabilities, operating systems, etc. Client synchronization service 138 can synchronize any changes (e.g., new, deleted, modified, copied, or moved content items) to content items in a designated location of a file system of client device 134.

Content items can be synchronized from client device 134 to content management system 102, and vice versa. In embodiments wherein synchronization is from client device 134 to content management system 102, a subject can manipulate content items directly from the file system of client device 134, while client synchronization service 138 can monitor directory on client device 134 for changes to files within the monitored folders.

When client synchronization service 138 detects a write, move, copy, or delete of content in a directory that it monitors, client synchronization service 138 can synchronize the changes to content item storage service 106. In some embodiments, client synchronization service 138 can perform some functions of content item storage service 106 including functions addressed above such as dividing the content item into blocks, hashing the content item to generate a unique identifier, etc. Client synchronization service 138 can index content within client storage index 142 and save the result in client storage index 142. Indexing can include storing paths plus the content item identifier, and a unique identifier for each content item. In some embodiments, client synchronization service 138 learns the content item identifier from server synchronization service 104, and learns the unique client identifier from the operating system of client device 134.

Client synchronization service 138 can use storage index 142 to facilitate the synchronization of at least a portion of the content items within client storage with content items associated with a subject account on content management system 102. For example, client synchronization service 138 can compare storage index 142 with content management system 102 and detect differences between content on client storage and content associated with a subject account on content management system 102. Client synchronization service 138 can then attempt to reconcile differences by uploading, downloading, modifying, and deleting content on client storage as appropriate. Content item storage service 106 can store the changed or new block for the content item and update content items database 132, metadata database 130, content item directory 126, content item storage 124, subject database 122, etc. as appropriate.

When synchronizing from content management system 102 to client device 134, data regarding a mount, modification, addition, deletion, move of a content item recorded in content items database 132 can trigger a notification to be sent to client device 134 using notification service 108. When client device 134 is informed of the change, client device 134 can make a request for changes listed in content items database 132 since the last synchronization point known to the client device. When client device 134 determines that it is out of synchronization with content management system 102, client synchronization service 138 requests content item blocks including the changes, and updates its local copy of the changed content items.

In some embodiments, storage index 142 stores tree data structures wherein one tree reflects the latest representation of a directory according to server synchronization service 104, while another tree reflects the latest representation of the directory according to client synchronization service 138. Client synchronization service 138 can work to ensure that the tree structures match by requesting data from server synchronization service 104 or committing changes on client device 134 to content management system 102.

Sometimes client device 134 might not have a network connection available. In this scenario, client synchronization service 138 can monitor the linked collection for content item changes and queue those changes for later synchronization to content management system 102 when a network connection is available. Similarly, a subject can manually start, stop, pause, or resume synchronization with content management system 102.

Client synchronization service 138 can synchronize all content associated with a particular subject account on content management system 102. Alternatively, client synchronization service 138 can selectively synchronize some of the content items associated with the particular subject account on content management system 102. Selectively synchronizing only some of the content items can preserve space on client device 134 and save bandwidth.

In some embodiments, client synchronization service 138 selectively stores a portion of the content items associated with the particular subject account and stores placeholder content items in client storage for the remainder portion of the content items. For example, client synchronization service 138 can store a placeholder content item that has the same filename, path, extension, metadata, of its respective complete content item on content management system 102, but lacking the data of the complete content item. The placeholder content item can be a few bytes or less in size while the respective complete content item might be significantly larger. After client device 134 attempts to access the content item, client synchronization service 138 can retrieve the data of the content item from content management system 102 and provide the complete content item to client device 134. This approach can provide significant space and bandwidth savings while still providing full access to a subject's content items on content management system 102.

While the synchronization embodiments addressed above referred to client device 134 and a server of content management system 102, it should be appreciated by those of ordinary skill in the art that a user account can have any number of client devices 134 all synchronizing content items with content management system 102, such that changes to a content item on any one client device 134 can propagate to other client devices 134 through their respective synchronization with content management system 102.

### Collaboration Features

Another feature of content management system 102 is to facilitate collaboration between subjects. Collaboration features include content item sharing, commenting on content items, co-working on content items in real time, instant messaging, providing presence and “seen” state information regarding content items, etc.

### Sharing and Tracking Service

Content management system 102 can manage sharing content items via sharing and tracking service 114. Sharing a content item by providing a link to the content item can include making the content item accessible from any computing device in network communication with content management system 102. However, in some embodiments, a link can be associated with access restrictions enforced by content management system 102 and Identity and Access Management service (IAM service) 118. Sharing a content item can also include linking the content item using sharing and tracking service 114 to share content items within content management system 102 with at least one additional subject account (in addition to the original subject account associated with the content item) so that each subject account has access to the content item. The additional subject account can gain access to the content item by accepting the content item, which will then be accessible through either web interface service 110 or directly from within the directory structure associated with their account on client device 134. The sharing can be performed in a platform agnostic manner. That is, the content item can be shared across multiple client devices 134 of varying type, capabilities, operating systems, etc. The content item can also be shared across varying types of subject accounts.

To share a content item within content management system 102, sharing and tracking service 114 can add associate a subject ID of a team or of one or more subject accounts with a content item in content items database 132 associated with the content item, thus granting the added subject account(s) access to the content item. Sharing and tracking service 114 can also remove subject IDs from being permitted to access a content item in content items database 132 to restrict a subject account's access to the content item. Sharing and tracking service 114 can record content item identifiers, subject identifiers given access to a content item, and access levels in content items database 132. For example, in some embodiments, subject identifiers associated with a single content item can specify different permissions for respective subject identifiers with respect to the associated content item.

In some embodiments, content management system 102 can include an access control list 128 which includes a description of complete access rights pertaining to a respective content item. An access control list for any respective content item in content management system can be derived from content items database 132. In some embodiments, it is not desirable to maintain a persistent access control list 128 for a respective content item, as an access control list 128 for a respective content item can be derived when needed. In some embodiments, content items can inherit access rights from another content item such as ancestor content items.

To share content items outside of content management system 102, sharing and tracking service 114 can generate a custom network address, such as a uniform resource locator (URL), which allows any web browser to access the content item or collection in content management system 102 without any authentication. To accomplish this, sharing and tracking service 114 can include content item identification data in the generated URL, which can later be used to properly identify and return the requested content item. For example, sharing and tracking service 114 can include a token identifying a content item ID and optionally a subject ID in the generated URL. Upon selection of the URL, the content item identification data included in the URL can be transmitted to content management system 102, which can use the received content item identification data to identify the appropriate content item and return the content item.

In addition to generating the URL, sharing and tracking service 114 can also be configured to record in content items database 132 that a URL to the content item has been created. In some embodiments, an entry into content items database 132 associated with a content item can include a URL flag indicating whether a URL to the content item has been created. For example, the URL flag can be a Boolean value initially set to 0 or false to indicate that a URL to the content item has not been created. Sharing and tracking service 114 can change the value of the flag to 1 or true after generating a URL to the content item.

In some embodiments, sharing and tracking service 114 can associate a set of permissions to a URL for a content item. For example, if a subject attempts to access the content item via the URL, sharing and tracking service 114 can provide a limited set of permissions for the content item. Examples of limited permissions include restrictions that the subject cannot download the content item, save the content item, copy the content item, modify the content item, etc. In some embodiments, limited permissions include restrictions that only permit a content item to be accessed from with a specified domain, i.e., from within a corporate network domain, or by accounts associated with a specified domain, e.g., accounts associated with a company account (e.g., @acme.com).

In some embodiments, sharing and tracking service 114 can also be configured to deactivate a generated URL. For example, each entry into content items database 132 can also include a URL active flag indicating whether the content item should be returned in response to a request from the generated URL. For example, sharing and tracking service 114 can only return a content item requested by a generated link if the URL active flag is set to 1 or true. Thus, access to a content item for which a URL has been generated can be easily restricted by changing the value of the URL active flag. This allows a subject to restrict access to the shared content item without having to move the content item or delete the generated URL. Likewise, sharing and tracking service 114 can reactivate the URL by again changing the value of the URL active flag to 1 or true. A subject can thus easily restore access to the content item without the need to generate a new URL.

In some embodiments, content management system 102 can designate a URL for uploading a content item. For example, a first subject with a subject account can request such a URL, provide the URL to a contributing subject and the contributing subject can upload a content item to the first subject's subject account using the URL.

In some cases, a content item sharing platform may utilize sharing and tracking service 114 to provide graphical displays such as a content item interaction analytics timeline. In some cases, the content item sharing platform is associated with or managed by content management system 102. In some embodiments, sharing and tracking service 114 provides access to granular viewer interactions for how viewers are viewing or interacting with shared content item over time. In such embodiments, sharing and tracking service 144 may provide viewer interactions that retrace a full journey of views of shared content items in a content item interaction analytics timeline.

The content item interaction analytics timeline may provide a visual representation of how the viewer interacts with the content item (e.g., how the user is scrolling through the different segments) throughout the viewing. In some cases, a preview of an associated segment associated with a representation of a user interaction in the content item interaction analytics timeline may be presented when a user hovers a mouse over the representation of a user interaction in the content item interaction analytics timeline. Furthermore, sharing and tracking service 144 may generate a plurality of different custom links or URLs for the same content item. Access through the different custom links may cause to generate different content item interaction analytics timelines.

### Team Service

In some embodiments content management system 102 includes team service 116. Team service 116 can provide functionality for creating and managing defined teams of subject accounts. Teams can be created for a company, with sub-teams (e.g., business units, or project teams, etc.), and subject accounts assigned to teams and sub-teams, or teams can be created for any defined group of subject accounts. Team service 116 can provide a common shared space for the team, private subject account folders, and access limited shared folders. Team service 116 can also provide a management interface for an administrator to manage collections and content items within team, and can manage subject accounts that are associated with the team. Teams, sub-teams, subject accounts are all given a subject identifier in subject database 122, and the membership to teams by subject accounts is also recorded in subject database 122.

### IAM (Identity and Access Management) Service

In some embodiments, content management system 102 includes IAM service 118. IAM service 118 can authenticate a subject account. For subject accounts with multiple levels of rights (e.g. a subject account with subject rights and administrator rights) IAM service 118 can also facilitate explicit privilege escalation to avoid unintentional actions by administrators.

### Content Item Access

Content item storage service 106 can receive a token from client application 136 that follows a request to access a content item and can return the capabilities permitted to the subject account.

### Presence and Seen State

In some embodiments, content management system 102 can provide information about how subjects with which a content item is shared are interacting or have interacted with the content item. In some embodiments, content management system 102 can report that a subject with which a content item is shared is currently viewing the content item. For example, client collaboration service 140 can notify notification service 108 when client device 134 is accessing the content item. Notification service 108 can then notify all client devices of other subjects having access to the same content item of the presence of the subject of client device 134 with respect to the content item.

In some embodiments, content management system 102 can report a history of subject interaction with a shared content item. Collaboration service 112 can query data sources such as metadata database 130 and content items database 132 to determine that a subject has saved the content item, that a subject has yet to view the content item, etc., and disseminate this status information using notification service 108 to other subjects so that they can know who currently is or has viewed or modified the content item.

Collaboration service 112 can facilitate comments associated with content, even if a content item does not natively support commenting functionality. Such comments can be stored in metadata database 130.

Collaboration service 112 can originate and transmit notifications for subjects. For example, a subject can mention another subject in a comment and collaboration service 112 can send a notification to that subject letting them know that they have been mentioned in the comment. Various other content item events can trigger notifications, including deleting a content item, sharing a content item, etc.

Collaboration service 112 can also provide a messaging platform whereby subjects can send and receive instant messages, voice calls, emails, etc.

### Collaboration Content Items

In some embodiments content management service can also include collaborative document service 120 which can provide an interactive content item collaboration platform whereby subjects can simultaneously create collaboration content items, comment in the collaboration content items, and manage tasks within the collaboration content items. Collaboration content items can be files that subjects can create and edit using a collaboration content item editor, and can contain collaboration content item elements. Collaboration content item elements may include a collaboration content item identifier, one or more author identifiers, collaboration content item text, collaboration content item attributes, interaction information, comments, sharing subjects, etc. Collaboration content item elements can be stored as database entities, which allows for searching and retrieving the collaboration content items. Multiple subjects may access, view, edit, and collaborate on collaboration content items at the same time or at different times. In some embodiments this can be managed by requiring two subjects access a content item through a web interface and there they can work on the same copy of the content item at the same time.

### Collaboration Companion Interface

In some embodiments client collaboration service 140 can provide a native application companion interface for the purpose of displaying information relevant to a content item being presented on client device 134. In embodiments wherein a content item is accessed by a native application stored and executed on client device 134, where the content item is in a designated location of the file system of client device 134 such that the content item is managed by client application 136, the native application may not provide any native way to display the above addressed collaboration data. In such embodiments, client collaboration service 140 can detect that a subject has opened a content item, and can provide an overlay with additional information for the content item, such as collaboration data. For example, the additional information can include comments for the content item, status of the content item, activity of other subjects previously or currently viewing the content item. Such an overlay can warn a subject that changes might be lost because another subject is currently editing the content item.

In some embodiments, one or more of the services or storages/databases discussed above can be accessed using public or private application programming interfaces.

Certain software applications can access content item storage 124 via an application programming interface (API) on behalf of a subject. For example, a software package such as an application running on client device 134, can programmatically make API calls directly to content management system 102 when a subject provides authentication credentials, to read, write, create, delete, share, or otherwise manipulate content.

A subject can view or manipulate a content item stored in a subject account via a web interface generated and served by web interface service 110. For example, the subject can navigate in a web browser to a web address provided by content management system 102. Changes or updates to the content item in the content item storage 124 made through the web interface, such as uploading a new version of a content item, can be propagated back to other client devices associated with the subject's account. For example, multiple client devices, each with their own client software, can be associated with a single account and content items in the account can be synchronized between each of the multiple client devices.

Client device 134 can connect to content management system 102 on behalf of a subject. A subject can directly interact with client device 134, for example when client device 134 is a desktop or laptop computer, phone, television, internet-of-things device, etc. Alternatively or additionally, client device 134 can act on behalf of the subject without the subject having physical access to client device 134, for example when client device 134 is a server.

Some features of client device 134 are enabled by an application installed on client device 134. In some embodiments, the application can include a content management system specific component. For example, the content management system specific component can be a stand-alone client application 136, one or more application plug-ins, and/or a browser extension. However, the subject can also interact with content management system 102 via a third-party application, such as a web browser, that resides on client device 134 and is configured to communicate with content management system 102. In various implementations, the client application 136 can present a subject interface (UI) for a subject to interact with content management system 102. For example, the subject can interact with the content management system 102 via a file system explorer integrated with the file system or via a webpage displayed using a web browser application.

In some embodiments, client application 136 can be configured to manage and synchronize the content item for more than one account of content management system 102. In such embodiments client application 136 can remain logged into multiple accounts and provide normal services for the multiple accounts. In some embodiments, each account can appear as folder in a file system, and all content items within that folder can be synchronized with content management system 102. In some embodiments, client application 136 can include a selector to choose one of the multiple accounts to be the primary account or default account.

### Third Party Services

In some embodiments content management system 102 can include functionality to interface with one or more third party services such as workspace services, email services, task services, etc. In such embodiments, content management system 102 can be provided with login credentials for a subject account at the third-party service to interact with the third party service to bring functionality or data from those third party services into various subject interfaces provided by content management system 102.

While content management system 102 is presented with specific components, it should be understood by one skilled in the art, that the architectural system configuration 100 is simply one possible configuration and that other configurations with more or fewer components are possible. Further, a service can have more or less functionality, even including functionality described as being with another service. Moreover, features described herein with respect to an embodiment can be combined with features described with respect to another embodiment.

While system 100 is presented with specific components, it should be understood by one skilled in the art, that the architectural system configuration 100 is simply one possible configuration and that other configurations with more or fewer components are possible.

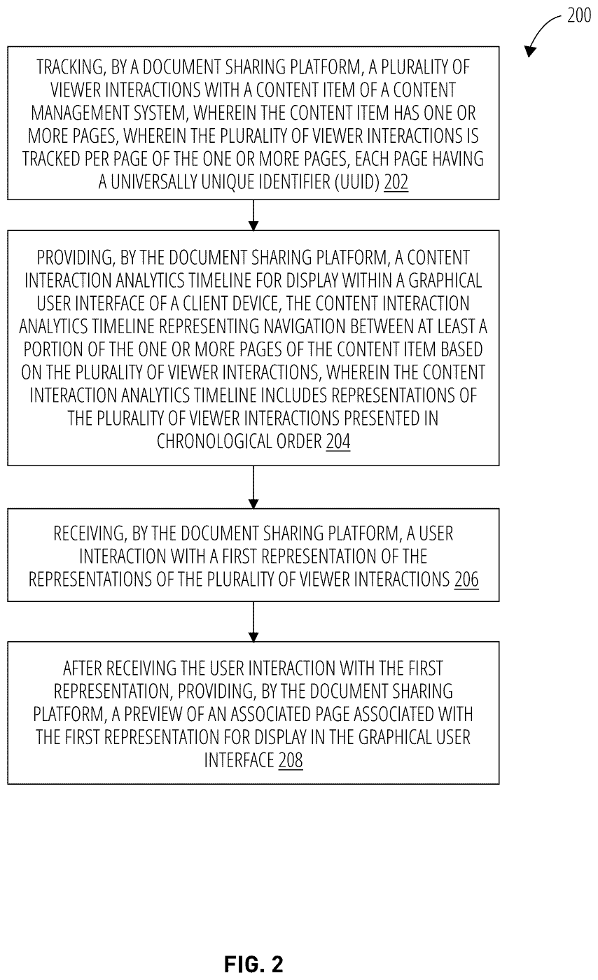

FIG. 2 illustrates example method 200 for generating a timeline view of navigation through a shared content item from a custom link in accordance with some aspects of the present technology. Although example method 200 depicts a particular sequence of operations, the sequence may be altered without departing from the scope of the present disclosure. For example, some of the operations depicted may be performed in parallel or in a different sequence that does not materially affect the function of method 200. In other examples, different components of an example device or system that implements the method 200 may perform functions at substantially the same time or in a specific sequence.

In some cases, a content item sharing platform may generate a content item interaction analytics timeline that visualizes a navigation of a shared content item shared using a custom link. The shared content item may be a document with pages, or may be virtual data rooms (VDR) containing sets of files that may include files of different formats (e.g., electronic documents, electronic spreadsheets, electronic portfolios). The content item may be received and parsed into segments (e.g., pages) and assigned universally unique identifiers (UUIDs) prior to being shared by the content item sharing platform.

To start, a content item sharing platform (e.g., through sharing and tracking service 144) associated with or managed by the content management system may first receive one or more content items that are to be shared. In some cases, the content item sharing platform parses such content items into segments (e.g., pages, cells, links, sections, etc.). The content item sharing platform may assign UUIDs to the segments and may further determine whether the received content item is renderable in its current form. If it is, then the received content item may be shared and if not, the received content item may be first converted into another format. A link may be created for the content item and shared such that views of the linked content item is tracked to generate granular viewer interactions. The linked content item may be further stored at the content management system.

The content item may then be shared through a custom link. In some cases, a request to generate a custom link associated with a content item may be received at first time. Then, a request to access the custom link may be received at a second time. In response to the request to access the content item, the content item may be provided, such as in a web browser. A plurality of viewer interactions may be tracked, such as through the web browser, based on receiving a UUID associated with a currently viewed segment of the content item. In some cases, the change to a currently viewed segment and associated UUID may be received with a respective timestamp.

According to some examples, the method includes tracking, by a content item sharing platform, a plurality of viewer interactions with the content item of a content management system at block 202. In some cases, sharing and tracking service 144 or content management system 102 may track the plurality of viewer interactions. In some cases, the content item has one or more segments, such as pages. In some cases, the plurality of viewer interactions may be tracked per segment of the one or more segments, wherein the segment may have a respective UUID. In some cases, the tracked UUIDs may be based on receiving a different UUID associated with a currently viewed segment of the at least one content item.

Furthermore, how a viewer navigates through the shared content item may be captured using UUIDs associated with unique segments. In some cases, a directory interface may be presented, which may include a plurality of content items.

According to some examples, the method includes providing, by the content item sharing platform, the content item interaction analytics timeline for display within a graphical user interface of a client device at block 204. The content item interaction analytics timeline may represent navigation between at least a portion of the one or more segments of the content item based on the plurality of viewer interactions. The content item interaction analytics timeline may include representations of the plurality of viewer interactions presented in chronological order. In some cases, sharing and tracking service 144 or content management system 102 provides the content item interaction analytics timeline.

In some cases, the plurality of viewer interactions may include segment change events, link selection events, download events, element selection events, whether a viewer has zoomed in or out, print actions, laser pointing in tracking live presentations, etc. In some cases, based on the analysis of the plurality of viewer interactions, an option to generate a summary for how a viewer viewed the content item may be provided. An option to categorize the viewer based on a viewer type may also be provided. The summary may be generated by a machine learning model such as a generative AI, to summarize how the viewer viewed the content item based on the data points associated with the plurality of viewer interactions. Furthermore, the viewer may be categorized into a type of viewer (e.g., a skimmer, an analytical viewer, etc) to further aggregate associated data points and create patterns. For example, once the viewers are categorized, it may be summarized that skimmers typically skip segments 4-10 while analytical viewers focus on page 9. This may help with creating custom content items for different audiences.

According to some examples, the method includes receiving, by the content item sharing platform, a user interaction with a first representation of the representations of the plurality of viewer interactions at block 206. In some cases, sharing and tracking service 144 or content management system 102 may receive the user interaction. For example, a user interaction may include hovering over the representation of the viewer interaction.

According to some examples, the method includes providing, by the content item sharing platform, a preview of an associated segment associated with the first representation for display in the graphical user interface at block 208. In some cases, sharing and tracking service 144 or content management system 102 may provide the preview after receiving the user interaction with the first representation. In addition, a selection of the preview may be received. In some cases, a window may be caused to open to link to the associated segment. In some cases, one or more actionable insights may be presented in the window to provide an option to execute a respective change. For example, an actionable insight may be to rearrange some segments to have the first couple of segments of the content item include the segments with the most time spent.

Furthermore, data points associated with the viewer interactions, such as segment views, download events, and content item link clicks, may be efficiently stored by aggregating the data points through an extract, transform, and load (ETL) pipeline. Some of the data points may be transformed before they are stored for a read use case as a way to store data more efficiently. For example, segment views may be indexed based on UUID (uuid) and/or based on visit ID and segment number (visit_id, segment_number). Similarly clicks on content item links may be indexed by content item link ID (content item_link_id) and/or by visit ID (visit_id). Timestamps for downloads may be stored on the visit itself when the content item is downloaded (visit.update (downloaded_at: time.now). The indexed data points may also be aggregated into a user-readable table or other type of graphical display.

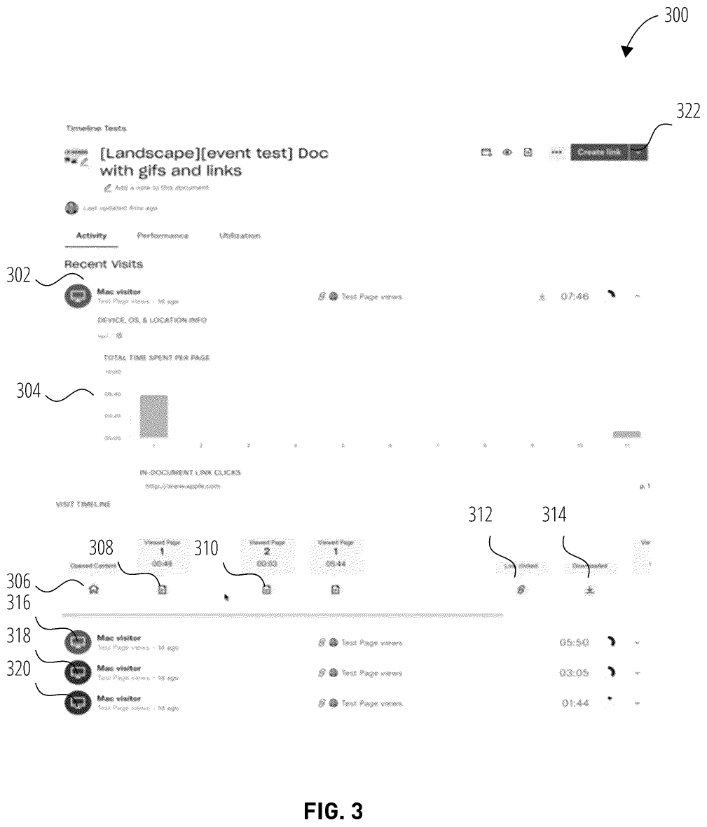

FIG. 3 illustrates example graphical display 300 that includes a content item interaction analytics timeline accordance with some aspects of the present technology.

A content item sharing platform may track a plurality of viewer interactions and may present the tracked interactions in one or more graphical displays. For example, in the example graphical display 300, viewer interactions for different visits are shown separately (e.g., first visit 302, second visit 316, third visit 318, fourth visit 320).

In some cases, a create link button 322 may be provided. An administrator who has access to content item interaction analytics for a particular content item may create custom links for sharing the content item. Each custom link may be provided to different viewers such that different visits by different viewers may be tracked separately.

The different graphical displays may include summary chart 304 and content item interaction analytics timeline 306. Summary chart 304 includes a total amount of time spent per segment (e.g., pages in FIG. 3), providing a quick overview of how the viewer split their time in viewing the different pages in first visit 302. As shown in summary chart 304, the viewer spent about six minutes and forty seconds on the first page and about less than one minute on the eleventh page.

However, summary chart 304 does not show how the user spent their viewing time. The content item interaction analytics timeline 306 provides a more granular view, providing data points such as a timestamp for when the user viewed page one (e.g., first representation of a user interaction 308), when the viewer switched to page two (e.g., second representation of a user interaction 310), when the viewer clicked a link (e.g., third representation of a user interaction 312), and when the viewer downloaded the content item (e.g., fourth representation of a user interaction 314).

In some cases, such data points are tracked based on receiving universally unique identifiers (UUIDs) associated with a currently viewed segment, such that when the currently viewed segment changes, a new UUID is received by the content item sharing platform.

By having insight to such a timeline and the temporal order in which the user interacted with the content item, an administrator may have a better understanding of what segments were more impactful and whether the content item needs to be updated for different types of viewers.

Furthermore, in some cases, the content item interaction analytics timeline 306 may be linked to the summary chart 304. The data points of the representation of user interactions of the content item interaction analytics timeline 306 may be linked to the data points of the total time spent per segment. For example, selecting one of the elements associated with a total time spent on a first page may highlight all the representation of user interactions associated with the first page on the content item interaction analytics timeline 306.

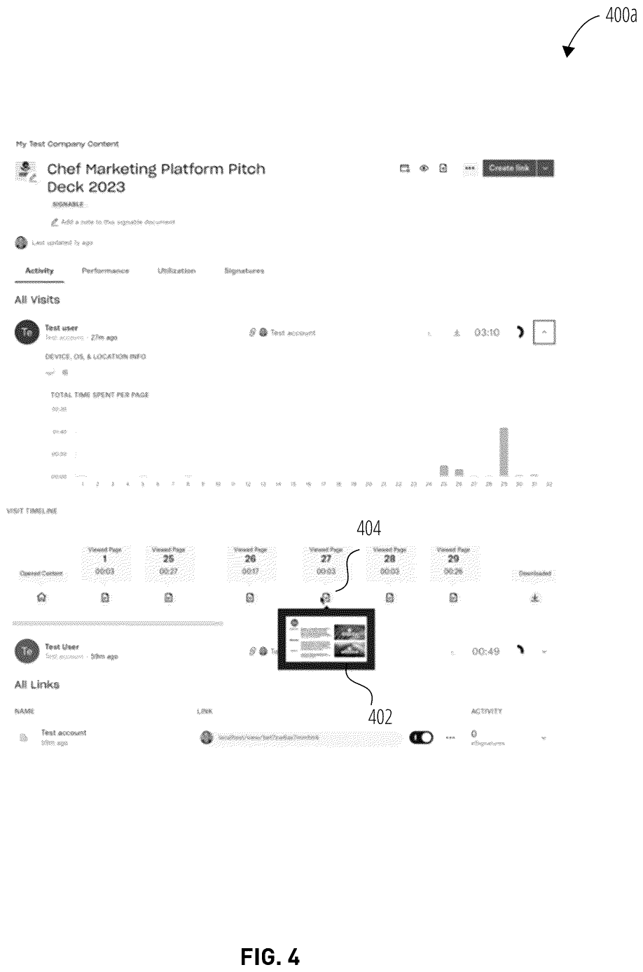

FIG. 4 illustrates an example graphical display 400 that includes a preview and a content item interaction analytics timeline in accordance with some aspects of the present technology.

In some cases, preview 402 of a respective segment (e.g., a page in FIG. 4) may be presented when a cursor hovers over a respective representation of a user interaction (e.g., fifth representation of a user interaction 404). In some cases, hovering over the respective representation of a user interaction may further generate actionable insights, such as changing a segment order, deleting a segment, moving a link, or providing a suggestion based on analysis of the viewer interactions.

In some cases, a selection of the preview may be received, and a window may be caused to open to link to the associated segment. In some cases, one or more actionable insights may be presented in the window to provide an option to execute a respective change. For example, an actionable insight may be to rearrange some segments to have the first couple of segments of the content item include the segments with the most time spent.

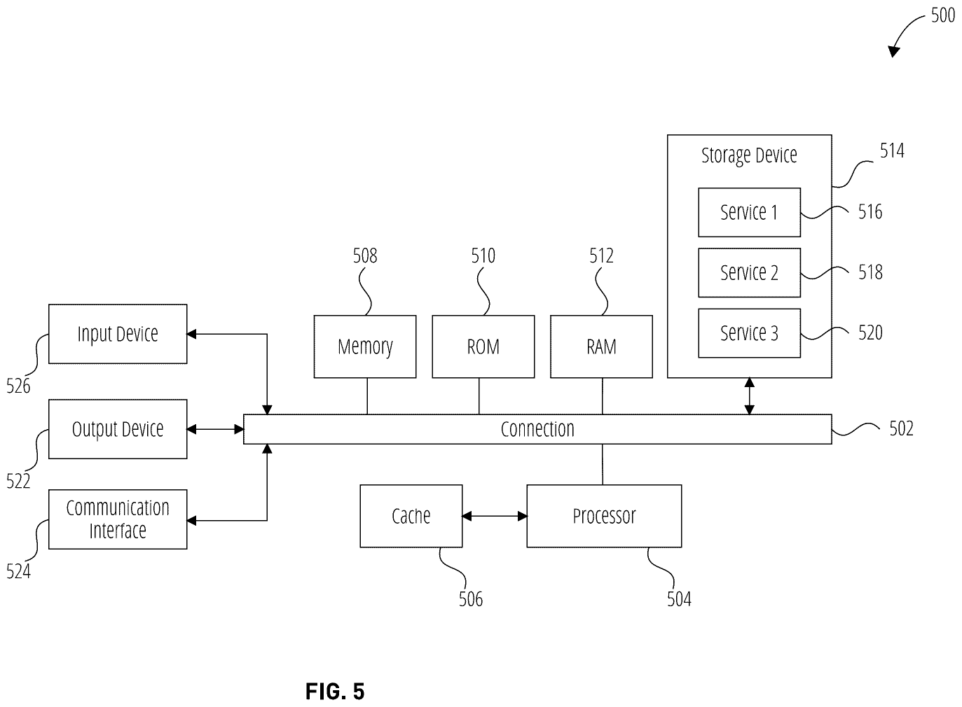

FIG. 5 shows an example of computing system 500, which can be for example any computing device making up content management system 102 or client devices 134, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 5088, such as read-only memory (ROM) 510 and random access memory (RAM) 512 to processor 504. Computing system 500 can include a cache of high-speed memory 508 connected directly with, in close proximity to, or integrated as part of processor 504.

Processor 504 can include any general purpose processor and a hardware service or software service, such as services 506, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that performs a particular function can include the software component stored in a computer-readable medium in connection with the hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method comprising:
tracking, by a content management system, a plurality of viewer interactions with a content item, wherein the content item has one or more segments, wherein the plurality of viewer interactions is tracked per segment of the one or more segments, each segment having a universally unique identifier (UUID);
providing, by the content management system, a content item interaction analytics timeline for display within a graphical user interface of a client device, the content item interaction analytics timeline representing navigation between at least a portion of the one or more segments of the content item based on the plurality of viewer interactions, wherein the content item interaction analytics timeline includes representations of the plurality of viewer interactions presented in chronological order;
receiving, by the content management system, a user interaction with a first representation of the representations of the plurality of viewer interactions; and
after receiving the user interaction with the first representation, providing, by the content management system, a preview of an associated segment associated with the first representation for display in the graphical user interface.

2. The computer-implemented method of claim 1, further comprising:
providing, within the graphical user interface of the client device, a directory interface comprising a plurality of content items including the content item stored at the content management system, wherein the plurality of viewer interactions includes segments from the plurality of content items.

3. The computer-implemented method of claim 1, further comprising:
providing one or more actionable insights in the content item interaction analytics timeline including changing a segment order, deleting a segment, moving a link, or providing a suggestion based on analysis of the plurality of viewer interactions.

4. The computer-implemented method of claim 3, further comprising:
receiving a selection of the preview; and
causing to open a window that links to the associated segment, wherein the one or more actionable insights are presented in the window to provide an option to execute a respective change.

5. The computer-implemented method of claim 1, wherein the plurality of viewer interactions includes segment change events, link selection events within a segment, download events, or segment element selection events.

6. The computer-implemented method of claim 1, further comprising:
receiving a request to generate a custom link associated with the content item;
receiving a request to access the custom link; and
in response to the request to access the custom link, providing the content item, wherein the plurality of viewer interactions are tracked based on receiving a universally unique identifier (UUID) associated with a currently viewed segment of the content item.

7. The computer-implemented method of claim 1 further comprising:
based on analysis of the plurality of viewer interactions, providing an option to generate a summary for how a viewer viewed the content item or an option to categorize the viewer based on viewer type.

8. The computer-implemented method of claim 1, further comprising:
linking the content item interaction analytics timeline with a summary chart that indicates how much time is spent on each segment by one or more viewers.

9. The computer-implemented method of claim 1, wherein the content item includes electronic content items, electronic spreadsheets, or electronic portfolios.

10. A computing system comprising:
at least one processor; and
a memory storing instructions that, when executed by the at least one processor, configure the computing system to:
track, by a content management system, a plurality of viewer interactions with a content item, wherein the content item has one or more segments, wherein the plurality of viewer interactions is tracked per segment of the one or more segments, each segment having a universally unique identifier (UUID);
provide, by the content management system, a content item interaction analytics timeline for display within a graphical user interface of a client device, the content item interaction analytics timeline representing navigation between at least a portion of the one or more segments of the content item based on the plurality of viewer interactions, wherein the content item interaction analytics timeline includes representations of the plurality of viewer interactions presented in chronological order;
receive, by the content management system, a user interaction with a first representation of the representations of the plurality of viewer interactions; and
after receiving the user interaction with the first representation, provide, by the content management system, a preview of an associated segment associated with the first representation for display in the graphical user interface.

11. The computing system of claim 10, wherein the instructions further configure the computing system to:
provide, within the graphical user interface of the client device, a directory interface comprising a plurality of content items including the content item stored at the content management system, wherein the plurality of viewer interactions includes segments from the plurality of content items.

12. The computing system of claim 11, wherein the instructions further configure the computing system to:
provide one or more actionable insights in the content item interaction analytics timeline including changing a segment order, deleting a segment, moving a link, or providing a suggestion based on analysis of the plurality of viewer interactions.

13. The computing system of claim 12, wherein the instructions further configure the computing system to:
receive a selection of the preview; and
cause to open a window that links to the associated segment, wherein the one or more actionable insights are presented in the window to provide an option to execute a respective change.

14. The computing system of claim 12, wherein the plurality of viewer interactions includes segment change events, link selection events within a segment, download events, or segment element selection events.

15. The computing system of claim 12, wherein the instructions further configure the computing system to:
receive a request to generate a custom link associated with the content item;
receive a request to access the custom link; and
in response to the request to access the custom link, provide the content item, wherein the plurality of viewer interactions are tracked based on receiving a universally unique identifier (UUID) associated with a currently viewed segment of the content item.

16. The computing system of claim 12, wherein the instructions further configure the computing system to:
based on analysis of the plurality of viewer interactions, provide an option to generate a summary for how a viewer viewed the content item or an option to categorize the viewer based on viewer type.

17. The computing system of claim 12, wherein the instructions further configure the computing system to:
link the content item interaction analytics timeline with a summary chart that indicates how much time is spent on each segment by one or more viewers.

18. The computing system of claim 12, wherein the content item includes electronic content items, electronic spreadsheets, or electronic portfolios.

19. A non-transitory computer-readable storage medium including instructions that when executed by at least one processor, cause the at least one processor to:
track, by a content management system, a plurality of viewer interactions with a content item, wherein the content item has one or more segments, wherein the plurality of viewer interactions is tracked per segment of the one or more segments, each segment having a universally unique identifier (UUID);
provide, by the content management system, a content item interaction analytics timeline for display within a graphical user interface of a client device, the content item interaction analytics timeline representing navigation between at least a portion of the one or more segments of the content item based on the plurality of viewer interactions, wherein the content item interaction analytics timeline includes representations of the plurality of viewer interactions presented in chronological order;
receive, by the content management system, a user interaction with a first representation of the representations of the plurality of viewer interactions; and
after receiving the user interaction with the first representation, provide, by the content management system, a preview of an associated segment associated with the first representation for display in the graphical user interface.

20. The non-transitory computer-readable storage medium of claim 19, wherein the instructions when executed by the at least one processor, cause the at least one processor to:
provide, within the graphical user interface of the client device, a directory interface comprising a plurality of content items including the content item stored at the content management system, wherein the plurality of viewer interactions includes segments from the plurality of content items.
